(19) United States
(12) Patent Application Publication
(10) Pub. No.: US 2021/0364182 A1
(43) Pub. Date: Nov. 25, 2021

(54) ENVIRONMENT ADJUSTMENT SYSTEM, ENVIRONMENT ADJUSTMENT METHOD AND COMPUTER READABLE MEDIUM

(71) Applicant: MITSUBISHI ELECTRIC CORPORATION, Tokyo (JP)

(72) Inventors: Ryoko NOMURA, Tokyo (JP); Tomooki UKIANA, Tokyo (JP); Takayoshi IIDA, Tokyo (JP); Yoshitaka UNO, Tokyo (JP)

(73) Assignee: MITSUBISHI ELECTRIC CORPORATION, Tokyo (JP)

(21) Appl. No.: 17/393,510

(22) Filed: Aug. 4, 2021

Related U.S. Application Data
(63) Continuation of application No. PCT/JP2019/012989, filed on Mar. 26, 2019.

(51) Int. Cl. F24F 11/47; F24F 11/63; G06F 21/31; F24F 11/50

(52) U.S. Cl. CPC F24F 11/47; F24F 11/63; F24F 2120/20; F24F 11/50; G06F 21/31

(57) ABSTRACT

A request acquisition unit (210) acquires a request regarding a subject environment which is an indoor environment to be adjusted. A control details decision unit (220) decides, based on the acquired request, details of adjustment by an adjustment device which is for adjusting the subject environment, and details of operation of a facility device which is a device of a different type from the adjustment device and affects the subject environment. A device control unit (230) controls the adjustment device according to the details of adjustment decided, and controls the facility device according to the details of operation decided.

### CROSS REFERENCE TO RELATED APPLICATIONS

This application is a Continuation of PCT International Application No. PCT/JP2019/012989 filed on Mar. 26, 2019, which is hereby expressly incorporated by reference into the present application.

### TECHNICAL FIELD

The present invention relates to a method of adjusting an indoor environment according to requests of users.

### BACKGROUND ART

It is desired to improve comfort for residents by adjusting an interior thermal environment according to requests of the residents.

Patent Literature 1 discloses a system that controls air conditioning and heating equipment according to the requests of the residents.

### CITATION LIST

### Patent Literature

Patent Literature 1: JP2010-25546A

### SUMMARY OF INVENTION

### Technical Problem

The air conditioning and heating equipment has more energy consumption than other pieces of equipment.

Therefore, if only the air conditioning and heating equipment is used to adjust the thermal environment, the energy consumption greatly increases.

The present invention aims to enable adjusting an indoor environment according to requests of users without greatly increasing an energy consumption.

### Solution to Problem

An environment adjustment system according to the present invention includes:

a request acquisition unit to acquire a request regarding a subject environment which is an indoor environment to be adjusted;
a control details decision unit to decide, based on the acquired request, details of adjustment by an adjustment device which is for adjusting the subject environment, and details of operation of a facility device which is a device of a different type from the adjustment device and affects the subject environment; and
a device control unit to control the adjustment device according to the details of adjustment decided, and control the facility device according to the details of operation decided.

### Advantageous Effects of Invention

According to the present invention, it is possible to adjust a thermal environment by using not only an air conditioner and heater but also a lighting instrument and a ventilation device. The air conditioner and heater is an example of an adjustment device. The lighting instrument and the ventilation device are examples of a facility device. The thermal environment is an example of a subject environment.

Therefore, it is possible to suppress an energy consumption as compared with a case where only the air conditioner and heater is used.

Therefore, it is possible to adjust an indoor environment according to requests of users without greatly increasing the energy consumption.

### BRIEF DESCRIPTION OF DRAWINGS

FIG. 1 is a configuration diagram of an environment adjustment system 100 according to a first embodiment;

FIG. 2 is a configuration diagram of an environment adjustment apparatus 200 according to the first embodiment;

FIG. 3 is a flow chart of an environment adjustment method according to the first embodiment;

FIG. 4 is a flowchart of a request acquisition process (S110) according to the first embodiment;

FIG. 5 is a configuration diagram of an environment adjustment system 100 according to a second embodiment;

FIG. 6 is a flow chart of an environment adjustment method according to the second embodiment;

FIG. 7 is a flowchart of a request acquisition process (S210) according to the second embodiment;

FIG. 8 is a flow chart of an environment adjustment method according to a third embodiment;

FIG. 9 is a flowchart of a request acquisition process (S310) according to the third embodiment;

FIG. 10 is a configuration diagram of an environment adjustment apparatus 200 according to a fourth embodiment;

FIG. 11 is a flow chart of an environment adjustment method according to the fourth embodiment;

FIG. 12 is a configuration diagram of an environment adjustment system 100 according to a fifth embodiment;

FIG. 13 is a configuration diagram of an environment adjustment apparatus 200 according to the fifth embodiment;

FIG. 14 is a flowchart of an environment adjustment method according to the fifth embodiment;

FIG. 15 is a flowchart of an environment adjustment method according to a sixth embodiment;

FIG. 16 is a configuration diagram of an environment adjustment system 100 according to a seventh embodiment;

FIG. 17 is a flowchart of an environment adjustment method according to the seventh embodiment;

FIG. 18 is a flowchart of a request acquisition process (S710) according to the seventh embodiment; and

FIG. 19 is a hardware configuration diagram of the environment adjustment apparatus 200 according to the embodiments.

### DESCRIPTION OF EMBODIMENTS

In descriptions of the embodiments and the drawings, the same reference numerals are assigned to the same elements or corresponding elements. Descriptions of elements assigned with the same reference numerals as the described elements will be omitted or simplified as appropriate. Arrows in the drawings mainly indicate flows of data or flows of processes.

### First Embodiment

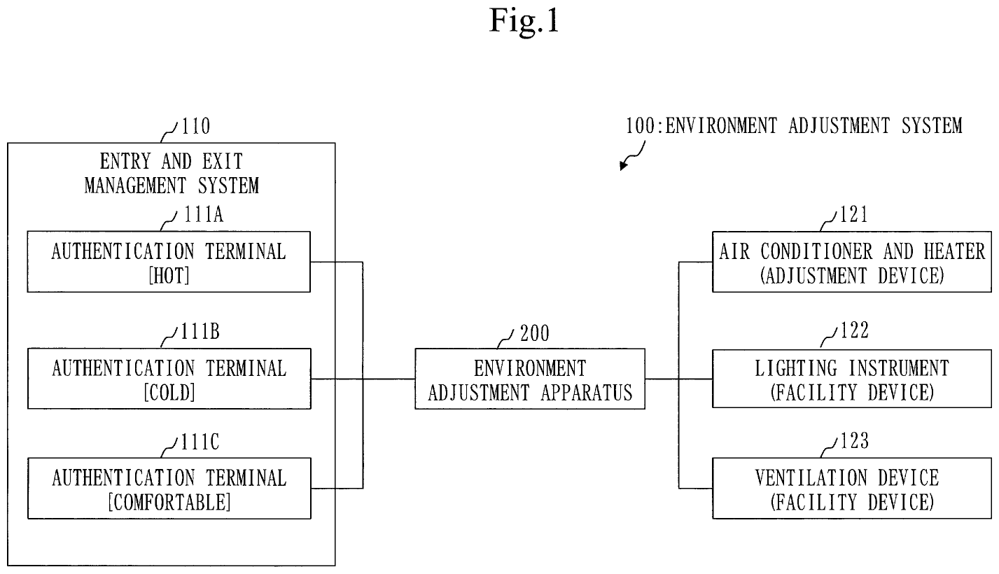

An environment adjustment system 100 will be described with reference to FIGS. 1 to 4.

The environment adjustment system 100 is provided in a structure such as a building, an office, or a commercial facility, and adjusts an indoor environment such as temperature or brightness.

The indoor environment to be adjusted is referred to as a “subject environment”.

In a first embodiment, by taking a case where the subject environment is “temperature”, as an example, descriptions will be given.

### Description of Configuration

A configuration of the environment adjustment system 100 will be described with reference to FIG. 1.

The environment adjustment system 100 includes various types of devices such as an air conditioner and heater 121, a lighting instrument 122, and a ventilation device 123.

The air conditioner and heater 121 is a device for adjusting the “temperature” which is the subject environment.

Each of the lighting instrument 122 and the ventilation device 123 is not a device for the purpose of adjusting the “temperature”, but is a device that affects the “temperature”. For example, when the lighting instrument 122 is turned on, the lighting instrument 122 generates heat, and therefore, indoor temperature rises. When the lighting instrument 122 is turned off, heat generation stops, and therefore, the indoor temperature lowers. For example, when the ventilation device 123 operates, the indoor temperature becomes close to outside air temperature due to ventilation.

A device for adjusting the subject environment, such as the air conditioner and heater 121, is referred to as an “adjustment device”.

A device that is a device of a different type from the adjustment device and affects the subject environment, such as the lighting instrument 122 or the ventilation device 123, is referred to as a “facility device”.

The environment adjustment system 100 includes an entry and exit management system 110 and an environment adjustment apparatus 200.

The entry and exit management system 110 is a system that manages entry and exit of users, and includes a plurality of authentication terminals 111. The authentication terminal 111 is a terminal that the user uses to be authenticated at times of the entry and the exit.

The plurality of authentication terminals 111 are associated with a plurality of types of requests regarding the subject environment (temperature). Specifically, an authentication terminal 111A is associated with a request that it is desired to lower the temperature because it is “hot”. An authentication terminal 111B is associated with a request that it is desired to raise the temperature because it is “cold”. An authentication terminal 111C is associated with a request that it is desired not to change the temperature because it is “comfortable”.

The environment adjustment apparatus 200 controls both the adjustment device and the facility device based on the request associated with the authentication terminal 111 that has been used by the user.

The environment adjustment system 100 has an internal network such as an intranet.

The environment adjustment apparatus 200 communicates with each of the entry and exit management system 110 and various types of devices via the internal network.

That is, an external network such as the Internet is not used in communication for environment adjustment.

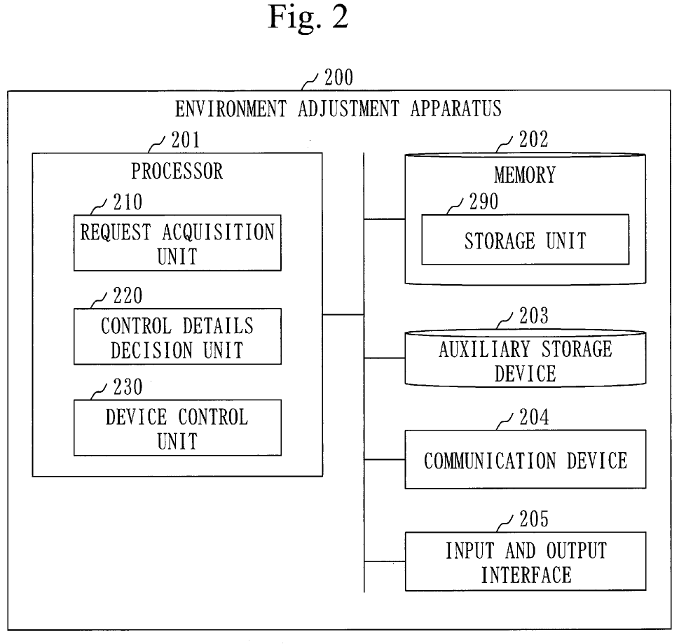

A configuration of the environment adjustment apparatus 200 will be described with reference to FIG. 2.

The environment adjustment apparatus 200 is a computer including pieces of hardware such as a processor 201, a memory 202, an auxiliary storage device 203, a communication device 204, and an input and output interface 205. These pieces of hardware are connected to each other via signal lines.

The processor 201 is an IC that performs a calculation process, and controls other pieces of hardware. For example, the processor 201 is a CPU, a DSP, or a GPU.

IC is an abbreviation for Integrated Circuit.

CPU is an abbreviation for Central Processing Unit.

DSP is an abbreviation for Digital Signal Processor.

GPU is an abbreviation for Graphics Processing Unit.

The memory 202 is a volatile storage device. The memory 202 is also referred to as a main storage device or a main memory. For example, the memory 202 is a RAM. Data stored in the memory 202 is stored in the auxiliary storage device 203 as necessary.

RAM is an abbreviation for Random Access Memory.

The auxiliary storage device 203 is a non-volatile storage device. For example, the auxiliary storage device 203 is a ROM, an HDD, or a flash memory. Data stored in the auxiliary storage device 203 is loaded into the memory 202 as necessary.

ROM is an abbreviation for Read Only Memory.

HDD is an abbreviation for Hard Disk Drive.

The communication devices 204 are a receiver and a transmitter. For example, the communication device 204 is a communication chip or an NIC.

NIC is an abbreviation for Network Interface Card.

The input and output interface 205 is a port to which an input device and an output device are connected. For example, the input and output interface 205 is a USB terminal, the input devices are a keyboard and a mouse, and the output device is a display.

USB is an abbreviation for Universal Serial Bus.

The environment adjustment apparatus 200 includes elements such as a request acquisition unit 210, a control details decision unit 220, and a device control unit 230. These elements are realized by software.

The auxiliary storage device 203 stores an environment adjustment program for causing a computer to function as the request acquisition unit 210, the control details decision unit 220, and the device control unit 230. The environment adjustment program is loaded into the memory 202 and executed by the processor 201.

The auxiliary storage device 203 further stores an OS. At least a part of the OS is loaded into the memory 202 and executed by the processor 201.

While executing the OS, the processor 201 executes the environment adjustment program.

OS is an abbreviation for Operating System.

The input and output data of the environment adjustment program is stored in a storage unit 290.

The memory 202 functions as the storage unit 290. However, storage devices such as the auxiliary storage device 203, a register in the processor 201, and a cache memory in the processor 201 may function as the storage unit 290 on behalf of the memory 202 or together with the memory 202.

The environment adjustment apparatus 200 may include a plurality of processors that replace the processor 201. The plurality of processors share a role of the processor 201.

The environment adjustment program can be recorded (stored) in a non-volatile recording medium such as an optical disk or a flash memory in a computer-readable manner.

### Description of Operation

Operation of the environment adjustment apparatus 200 is equivalent to an environment adjustment method. Further, a procedure of the environment adjustment method is equivalent to a procedure of the environment adjustment program.

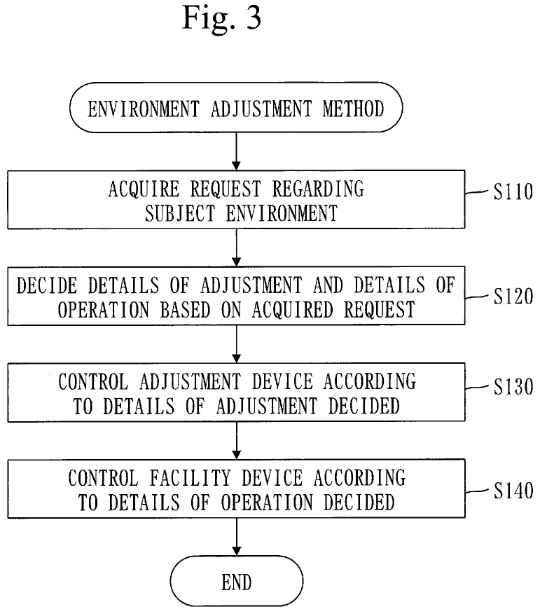

The environment adjustment method will be described with reference to FIG. 3.

In step S110, the request acquisition unit 210 acquires a request regarding the subject environment.

Specifically, the request acquisition unit 210 determines a request associated with the authentication terminal that has been used by the user, as the request regarding the subject environment.

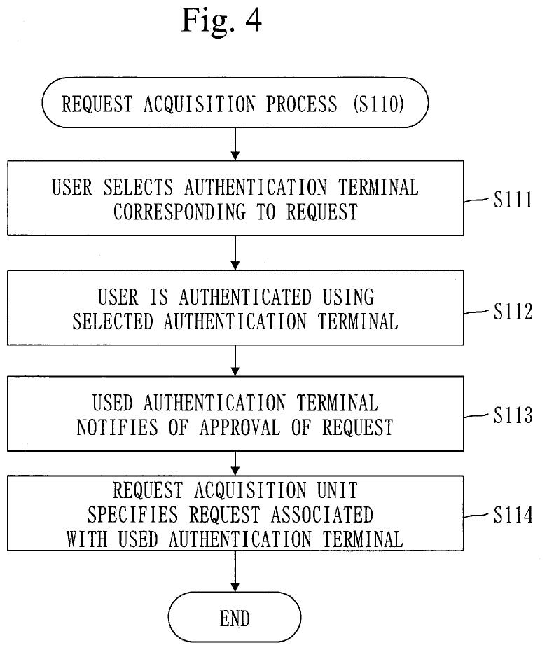

A procedure of a request acquisition process (S110) will be described with reference to FIG. 4.

In step S111, the user selects the authentication terminal 111 corresponding to the request regarding the subject environment from the plurality of authentication terminals 111.

In step S112, the user is authenticated using the selected authentication terminal 111.

For example, the authentication terminal 111 includes a card reader, and the user holds an ID card over the card reader.

The ID card is an IC card in which personal information of the user is recorded, and is also referred to as a personal identification card.

ID is an abbreviation for Identifier or Identification.

IC is an abbreviation for Integrated Circuit.

In step S113, a used authentication terminal 111 performs an authentication process.

When the request of the user is approved in the authentication process, the used authentication terminal 111 notifies the environment adjustment apparatus 200 that the request of the user has been approved.

In step S114, when the request acquisition unit 210 receives the notification from the used authentication terminal 111, the request acquisition unit 210 specifies the request associated with the used authentication terminal 111. The specified request is the request regarding the subject environment.

The request acquisition unit 210 specifies, for example, the request associated with the used authentication terminal 111 as follows.

A request table is stored in the storage unit 290 in advance. The request table associates the plurality of authentication terminals 111 and a plurality of types of requests with each other.

The request acquisition unit 210 acquires the request associated with the used authentication terminal 111 from the request table.

Returning to FIG. 3, descriptions continue from step S120.

In step S120, the control details decision unit 220 decides details of adjustment by the adjustment device and details of operation of the facility device based on the request regarding the subject environment.

Examples of the details of adjustment are indicated below.

When a request that it is desired to lower the temperature because it is “hot” is acquired, the detail of adjustment is to lower set temperature of the air conditioner and heater 121 a little.

When a request that it is desired to raise the temperature because it is “cold” is acquired, the detail of adjustment is to raise the set temperature of the air conditioner and heater 121 a little.

Examples of the details of operation are described below.

When a request that it is desired to lower the temperature because it is “hot” is acquired, the detail of operation is to lower an illuminance of the lighting instrument 122 and to operate (or stop) the ventilation device 123.

When a request that it is desired to raise the temperature because it is “cold” is acquired, the detail of operation is to raise the illuminance of the lighting instrument 122 and to stop (or operate) the ventilation device 123.

The control details decision unit 220 decides, for example, the details of adjustment and the details of operation as follows.

A control details table is stored in the storage unit 290 in advance. The control details table associates a plurality of types of requests and a plurality of control details with each other. Each of the control details includes the details of adjustment and the details of operation.

The control details decision unit 220 acquires from the control details table, the control details associated with the acquired request.

In step S130, the device control unit 230 controls the adjustment device according to the details of adjustment decided.

That is, the device control unit 230 controls the air conditioner and heater 121 according to the details of adjustment decided.

In step S140, the device control unit 230 controls the facility device according to the details of operation decided.

That is, the device control unit 230 controls each of the lighting instrument 122 and the ventilation device 123 according to the details of operation decided.

### Effect of First Embodiment

In the first embodiment, requests (hot/cold, satisfaction/dissatisfaction, and the like) of residents are collected by using in-building equipment (entry and exit management system 110). Then, various types of devices are controlled according to the collected requests. The devices to be controlled are not limited to the devices directly linked to the requests. For example, when the request of the resident is “cold”, not only the set temperature of the air conditioner and heater 121 is raised, but also color temperature of the lighting instrument 122 is changed to warm color.

By doing this, it is possible to adjust an interior environment according to the requests of the residents without greatly increasing an energy consumption.

Since the resident is authenticated by the entry and exit management system 110, it is possible to prevent the system from being used by an unrelated third party.

By the in-building equipment being used, it is possible to collect the requests of the residents by secure communication without connecting to an external network.

### Second Embodiment

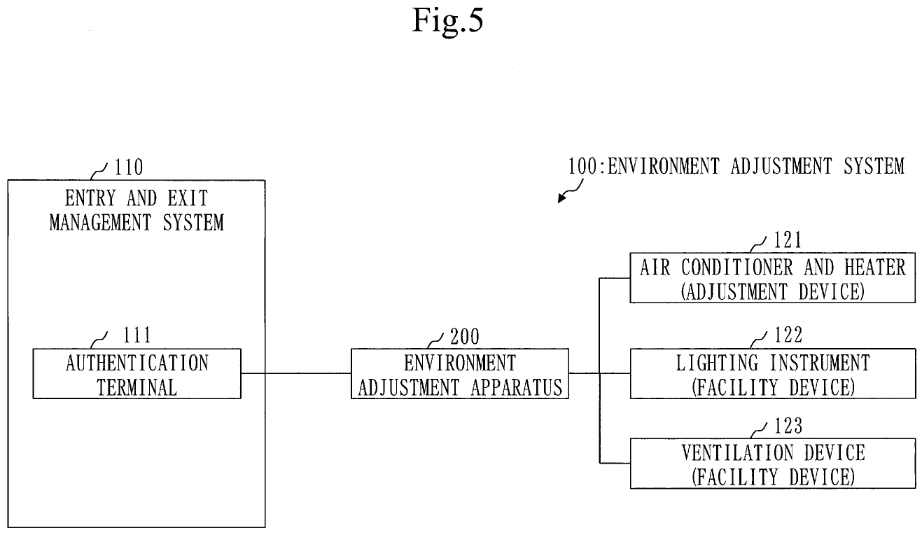

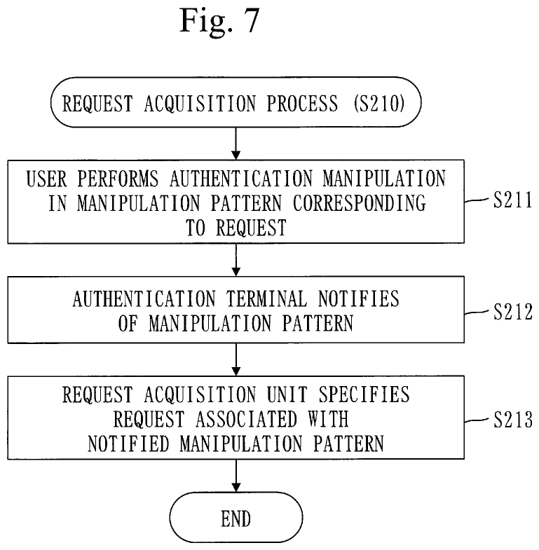

As to a mode in which the request regarding the subject environment is designated by manipulation on the authentication terminal 111, mainly matters different from the first embodiment will be described with reference to FIGS. 5 and 7.

### Description of Configuration

A configuration of the environment adjustment system 100 will be described with reference to FIG. 5.

The configuration of the environment adjustment system 100 is the same as the configuration in the first embodiment except for the configuration of the entry and exit management system 110.

The entry and exit management system 110 includes one authentication terminal 111 instead of the plurality of authentication terminals (111A to 111C) associated with the plurality of types of requests (see FIG. 1).

Manipulation on the authentication terminal 111 is referred to as “authentication manipulation”.

A pattern of the authentication manipulation is referred to as a “manipulation pattern”.

A plurality of manipulation patterns exist, and the plurality of manipulation patterns are associated with a plurality of types of requests.

The plurality of manipulation patterns are classified according to at least one of a manipulation time and the number of times of manipulation. The manipulation time is a length of time spent on the authentication manipulation. The number of times of manipulation is the number of times that the authentication manipulation is performed.

For example, the authentication terminal 111 includes a card reader. In this case, the authentication manipulation is an act of holding the ID card over the card reader. The manipulation time is a length of time that the ID card is held over the card reader. The number of times of manipulation is the number of times that the ID card is held over the card reader.

### Description of Operation

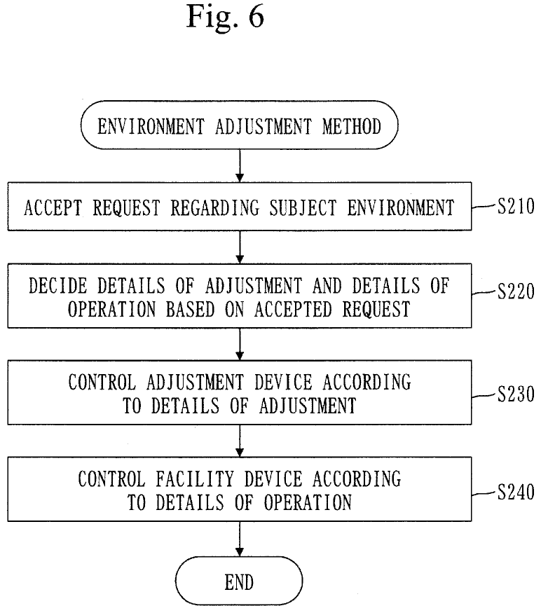

An environment adjustment method will be described with reference to FIG. 6.

A procedure of the environment adjustment method is the same as the procedure in the first embodiment (see FIG. 3).

However, a request acquisition process (S210) is different from the process (S110) in the first embodiment.

The request acquisition process (S210) will be described.

In step S210, the request acquisition unit 210 acquires the request regarding the subject environment.

Specifically, the request acquisition unit 210 determines a request associated with the manipulation pattern performed on the authentication terminal 111, as the request regarding the subject environment.

A procedure of the request acquisition process (S210) will be described with reference to FIG. 7.

In step S211, the user performs the authentication manipulation on the authentication terminal 111 in a manipulation pattern corresponding to the request regarding the subject environment.

For example, when feeling “hot”, the user holds the ID card over the card reader of the authentication terminal 111 once. Further, when feeling “cold”, the user holds the ID card over the card reader of the authentication terminal 111 twice.

In step S212, the authentication terminal 111 performs an authentication process.

When the request of the user is approved in the authentication process, the authentication terminal 111 notifies the environment adjustment apparatus 200 of the manipulation pattern that the user has performed.

In step S213, when the request acquisition unit 210 receives the notification of the manipulation pattern, the request acquisition unit 210 specifies the request associated with the notified manipulation pattern. The specified request is the request regarding the subject environment.

The request acquisition unit 210 specifies, for example, the request associated with the notified manipulation pattern as follows.

A request table is stored in the storage unit 290 in advance. The request table associates the plurality of manipulation patterns and the plurality of types of requests with each other.

The request acquisition unit 210 acquires the request associated with the notified manipulation pattern from the request table.

### Effect of Second Embodiment

The user can designate the request regarding the subject environment by the manipulation on the authentication terminal 111. Therefore, it is unnecessary to prepare the authentication terminal 111 for each request. Therefore, it is possible to suppress a cost of the system.

### Third Embodiment

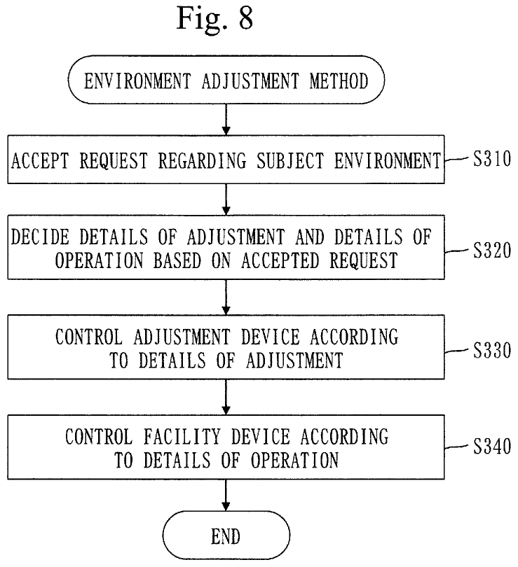

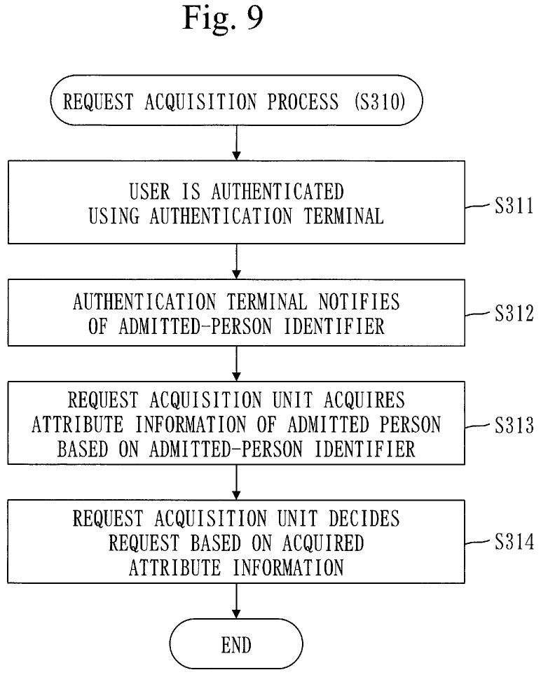

As to a mode in which the request of the user is decided based on attributes (gender, age, and the like) of the user, mainly matters different from the first embodiment and the second embodiment will be described with reference to FIGS. 8 and 9.

### Description of Configuration

A configuration of the environment adjustment system 100 is the same as the configuration in the second embodiment (see FIG. 5).

A configuration of the environment adjustment apparatus 200 is the same as the configuration in the first embodiment (see FIG. 2).

### Description of Operation

An environment adjustment method will be described with reference to FIG. 9.

A procedure of the environment adjustment method is the same as the procedure in the first embodiment (see FIG. 3).

However, a request acquisition process (S310) is different from the process (S110) in the first embodiment.

The request acquisition process (S310) will be described.

In step S310, the request acquisition unit 210 accepts the request regarding on the subject environment.

Specifically, the request acquisition unit 210 acquires a user identifier that identifies an approved user, from the authentication terminal 111, acquires attribute information of the approved user based on the acquired user identifier, and decides the request regarding the subject environment based on the acquired attribute information.

An admitted person identifier identifies an admitted person.

The admitted person is a user who is approved for entry.

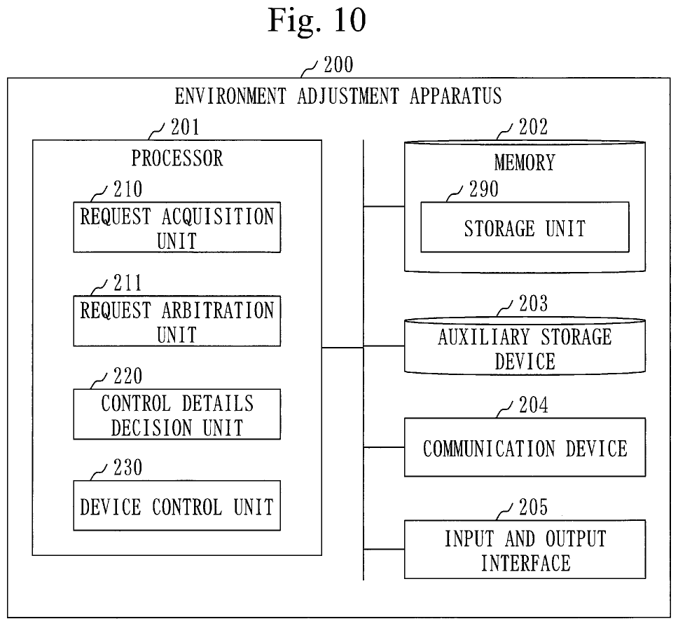

A request acquisition process (S310) will be described with reference to FIG. 10.

In step S311, the user is authenticated using the authentication terminal 111.

For example, the authentication terminal 111 includes a card reader, and the user holds the ID card over the card reader.

In step S312, the authentication terminal 111 performs an authentication process.

When the entry of the user is approved in the authentication process, the authentication terminal 111 notifies the environment adjustment apparatus 200 of an identifier of the user. The notified identifier is referred to as an “admitted-person identifier”. A user identified by the admitted-person identifier is referred to as an “admitted person”.

In step S313, when the request acquisition unit 210 receives the notification of the admitted-person identifier, the request acquisition unit 210 acquires the attribute information of the admitted person based on the notified admitted-person identifier.

The request acquisition unit 210 acquires, for example, the attribute information of the admitted person as follows.

A user database is stored in the storage unit 290 in advance. The user database has user data for each user. The user data includes the user identifier and the attribute information.

The request acquisition unit 210 acquires from the user database, the user data including the same user identifier as the admitted-person identifier, and acquires the attribute information from the acquired user data.

In step S314, the request acquisition unit 210 decides the request regarding the subject environment based on the acquired attribute information.

An example of the request to be decided will be described.

When the attribute information is information of “elderly” or information of “female”, the request to be decided is a request that it is desired to raise the temperature.

The request acquisition unit 210 decides, for example, the request regarding the subject environment as follows.

A request table is stored in the storage unit 290 in advance. The request table associates a plurality of types of attribute information and a plurality of types of requests with each other.

The request acquisition unit 210 acquires the request associated with the acquired attribute information from the request table.

### Effect of Third Embodiment

In the third embodiment, the request of the user is presumed based on the attributes of the user. The user does not need to designate his or her own request. Therefore, it is possible to provide a comfortable environment for the user without requiring the user to perform manipulation for designating the request.

### Fourth Embodiment

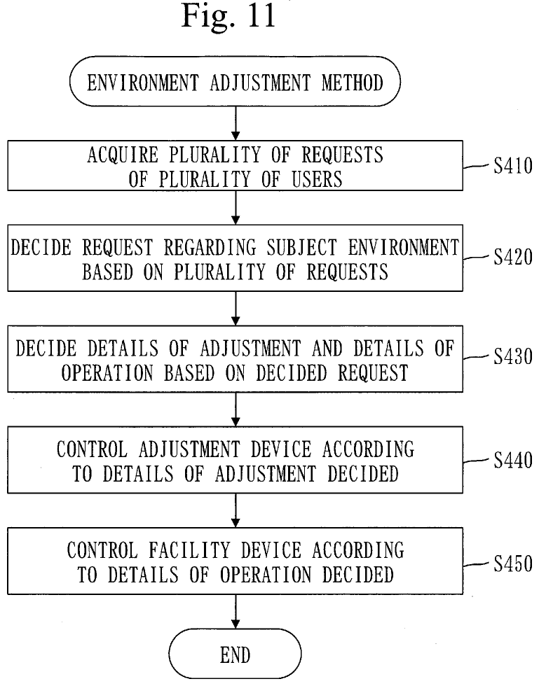

As to a mode in which requests of a plurality of users are arbitrated, mainly matters different from the first embodiment will be described with reference to FIGS. 10 and 11.

### Description of Configuration

A configuration of the environment adjustment system 100 is the same as the configuration in the first embodiment.

A configuration of the environment adjustment apparatus 200 will be described with reference to FIG. 10.

The environment adjustment apparatus 200 further includes a request arbitration unit 211.

An environment adjustment program further causes a computer to function as the request arbitration unit 211.

### Description of Operation

An environment adjustment method will be described with reference to FIG. 11.

In step S410, the request acquisition unit 210 acquires a plurality of requests of a plurality of users.

Specifically, the request acquisition unit 210 acquires the plurality of requests of the plurality of users in the venue from the entry and exit management system 110. That is, the request acquisition unit 210 acquires the plurality of requests of the plurality of users who have not exited after the entry.

A method of acquiring the request of each user is the same as the method in step S110 in the first embodiment.

In step S420, the request arbitration unit 211 decides the request regarding the subject environment based on the plurality of requests acquired.

For example, the request arbitration unit 211 decides the request regarding the subject environment by a majority vote. That is, the request arbitration unit 211 selects the most requested request among the plurality of requests acquired.

Steps S430 to S450 are the same as steps S120 to S140 in the first embodiment.

### Effect of Fourth Embodiment

In the fourth embodiment, the requests of the plurality of users are arbitrated. By doing this, it is possible to provide an environment which is comfortable for more users.

### Supplement to Fourth Embodiment

The fourth embodiment may be combined with the second embodiment or the third embodiment.

That is, the configuration of the environment adjustment system 100 may be the same as the configuration in the second embodiment or the third embodiment.

Further, in step S410, the method of acquiring the request of each user may be the same as the method in step S210 in the second embodiment or the method in step S310 in the third embodiment.

### Fifth Embodiment

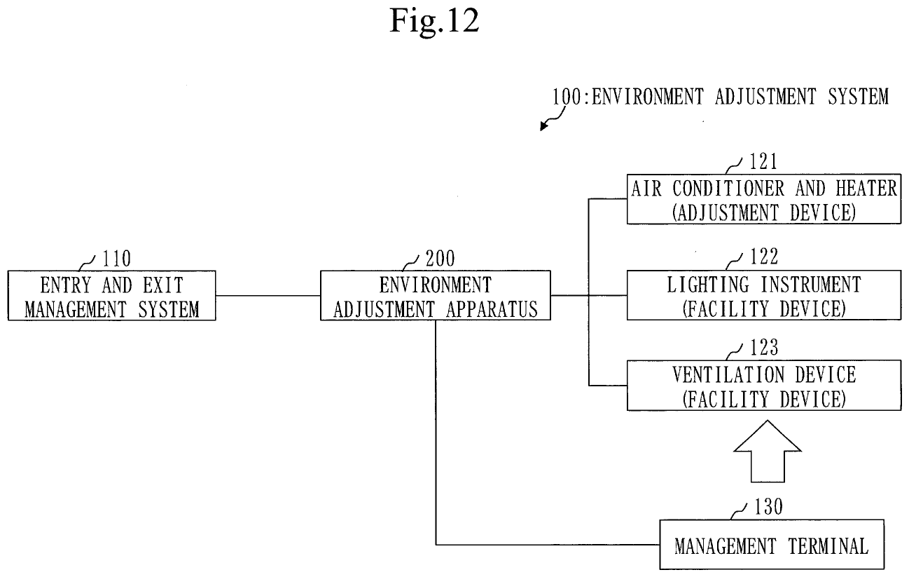

As to a mode in which the request regarding the subject environment is displayed on a terminal of a manager, mainly matters different from the first embodiment will be described with reference to FIGS. 12 to 14.

### Description of Configuration

A configuration of the environment adjustment system 100 will be described with reference to FIG. 12.

The configuration of the environment adjustment system 100 is the same as the configuration in the first embodiment except for a management terminal 130.

The environment adjustment system 100 includes the management terminal 130.

The management terminal 130 is a terminal capable of controlling each of the adjustment device and the facility device. For example, the management terminal 130 is placed in a management room. Then, the manager controls each of the adjustment device and the facility device by manipulating the management terminal 130.

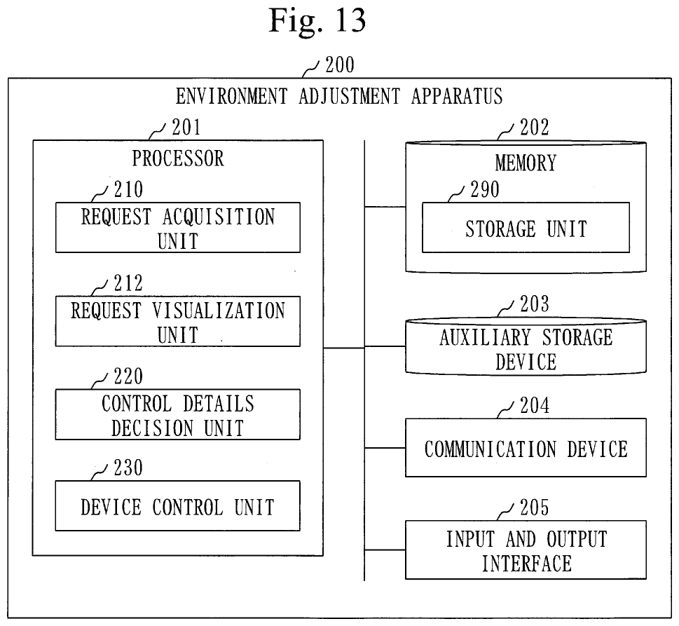

A configuration of the environment adjustment apparatus 200 will be described with reference to FIG. 13.

The environment adjustment apparatus 200 further includes a request visualization unit 212.

The environment adjustment program further causes a computer to function as the request visualization unit 212.

### Description of Operation

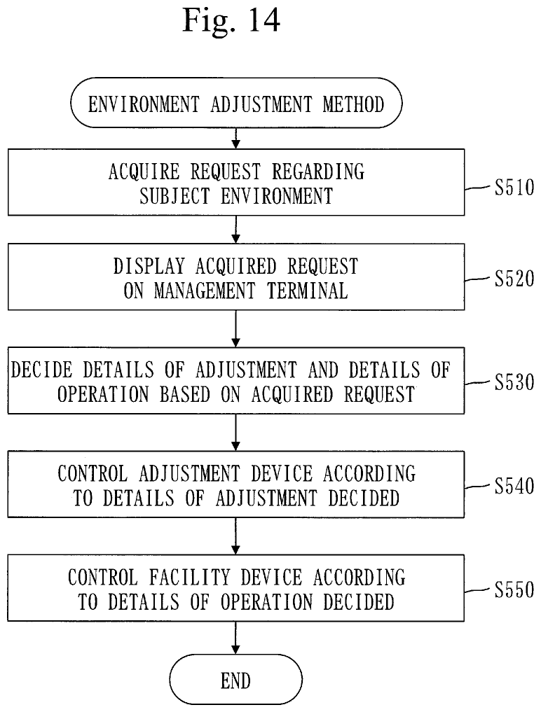

An environment adjustment method will be described with reference to FIG. 14.

In step S510, the request acquisition unit 210 acquires the request regarding the subject environment.

Step S510 is the same as step S110 in the first embodiment.

In step S520, the request visualization unit 212 displays the acquired request on a display of the management terminal 130.

For example, the request visualization unit 212 notifies the management terminal 130 of the acquired request. Then, the management terminal 130 displays the notified request on the display.

Steps S530 to S550 are the same as steps S120 to S140 in the first embodiment.

### Effect of Fifth Embodiment

According to the fifth embodiment, it is possible to visualize the request of the user to the building manager. The building manager can adjust the in-building environment according to the visualized request without relying on automatic adjustment by the system.

### Supplement to Fifth Embodiment

The fifth embodiment may be combined with the second embodiment or the third embodiment. That is, the request acquisition unit 210 may acquire the request regarding the subject environment by the method in the second embodiment or the method in the third embodiment.

The fifth embodiment may be combined with the fourth embodiment. That is, the environment adjustment apparatus 200 may include the request arbitration unit 211. The request acquisition unit 210 acquires the plurality of requests of the plurality of users, the request arbitration unit 211 decides the request regarding the subject environment based on the plurality of requests, and the request visualization unit 212 displays the request regarding the subject environment on the management terminal 130.

### Sixth Embodiment

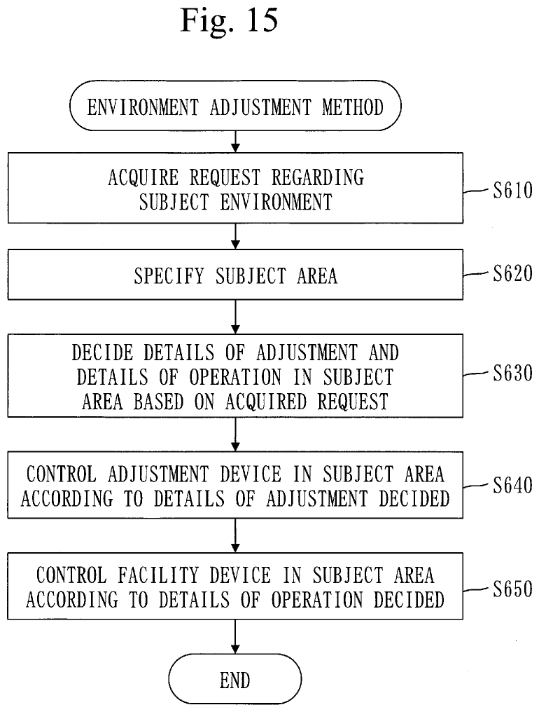

As to a mode in which the environment adjustment system 100 adjusts each subject environment of a plurality of areas, mainly matters different from the first embodiment will be described with reference to FIG. 15.

### Description of Configuration

A configuration of the environment adjustment system 100 is the same as the configuration in the first embodiment (see FIG. 1).

However, the environment adjustment system 100 includes a plurality of authentication terminals 111 in each of the plurality of areas. Further, the environment adjustment system 100 includes the adjustment device and the facility device in each of the plurality of areas.

### Description of Operation

The environment adjustment apparatus 200 implements an environment adjustment method for each area.

A procedure of the environment adjustment method will be described with reference to FIG. 15.

In step S610, the request acquisition unit 210 acquires the request regarding the subject environment.

Step S610 is the same as step 5110 in the first embodiment.

In step S620, the request acquisition unit 210 specifies an area which includes the authentication terminal 111 which has been used. The specified area is referred to as a “subject area”.

The request acquisition unit 210 specifies, for example, the subject area as follows.

An area management table is stored in the storage unit 290 in advance. The area management table indicates for each area, the authentication terminal 111 placed in the area.

The request acquisition unit 210 finds an area where the used authentication terminal 111 is placed, by searching in the area management table. The found area is the subject area.

In step S630, the control details decision unit 220 decides the details of adjustment by the adjustment device in the subject area and the details of operation of the facility device in the subject area based on the acquired request.

Methods of deciding the details of adjustment and the details of operation are the same as the methods in step S120 in the first embodiment.

In step S640, the device control unit 230 controls the adjustment device in the subject area according to the details of adjustment decided.

In step S650, the device control unit 230 controls the facility device in the subject area according to the details of operation decided.

### Effect of Sixth Embodiment

According to the sixth embodiment, it is possible to adjust for each room in a building, the environment in the room according to the request of the user in the room.

### Supplement to Sixth Embodiment

The sixth embodiment may be combined with one of the second embodiment to the fifth embodiment.

That is, the environment adjustment apparatus 200 may implement the environment adjustment method in one of the second embodiment to the fifth embodiment for each area.

### Seventh Embodiment

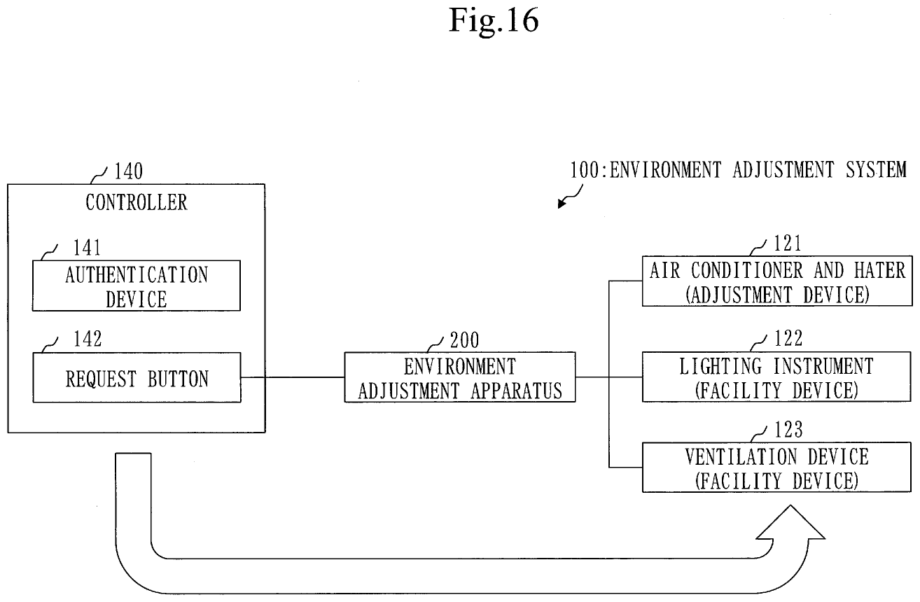

As to a mode in which the request regarding the subject environment is designated by using a controller which has an authentication function, mainly matters different from the first embodiment will be described with reference to FIGS. 16 to 18.

### Description of Configuration

A configuration of the environment adjustment system 100 will be described with reference to FIG. 16.

The environment adjustment system 100 includes a controller 140.

The controller 140 is a controller for controlling at least one of the adjustment device and the facility device.

The controller 140 includes an authentication device 141 and a request button 142.

The authentication device 141 is a device equivalent to the authentication terminal 111 of the entry and exit management system 110, and is used for authentication of the user.

The request button 142 is a button for designating the request regarding the subject environment. For example, the request button 142 is a plurality of buttons associated with a plurality of types of requests.

### Description of Operation

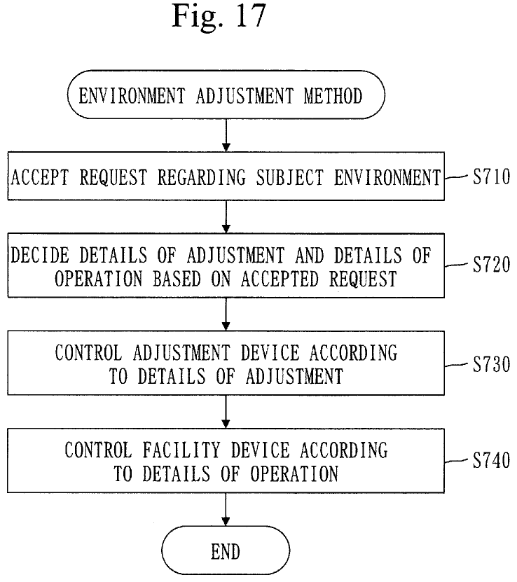

An environment adjustment method will be described with reference to FIG. 17.

A procedure of the environment adjustment method is the same as the procedure in the first embodiment (see FIG. 3).

However, a request acquisition process (S710) is different from the process in the first embodiment (S110).

The request acquisition process (S710) will be described.

In step S710, the request acquisition unit 210 acquires the request regarding the subject environment.

Specifically, when manipulation on the request button 142 is authenticated by the authentication device 141, the request acquisition unit 210 determines the request designated by the manipulation on the request button 142, as the request regarding the subject environment.

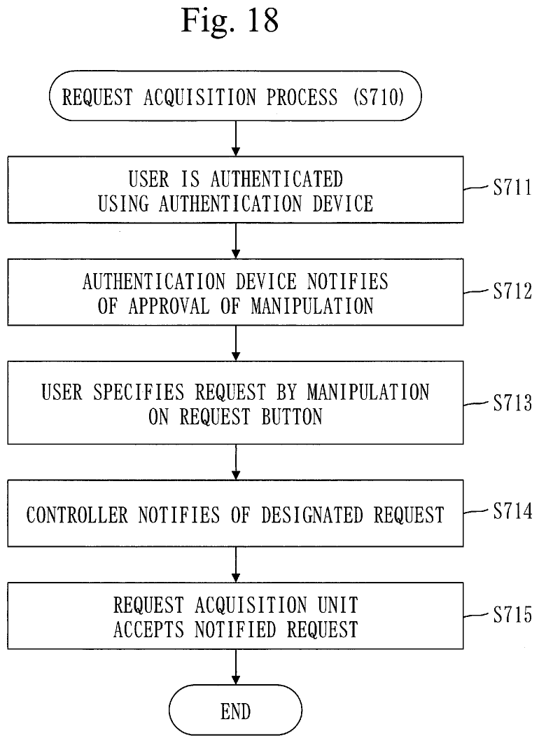

A procedure of the request acquisition process (S710) will be described with reference to FIG. 18.

In step S711, the user is authenticated using the authentication device 141.

For example, the authentication device 141 includes a card reader, and the user holds the ID card over the card reader.

In step S712, the authentication device 141 performs an authentication process.

When the manipulation on the request button 142 by the user is approved in the authentication process, the authentication device 141 notifies the user that the manipulation on the request button 142 has been approved.

For example, the controller 140 includes a display or a lamp. The authentication device 141 uses the display or the lamp to notify that the manipulation on the request button 142 has been approved.

In step S713, the user designates the request regarding the subject environment by manipulating the request button 142.

For example, the user presses a button for designating the request regarding the subject environment among a plurality of buttons which are prepared as the request button 142.

In step S714, the controller 140 notifies the environment adjustment apparatus 200 of the request associated with the manipulation on the request button 142.

In step S715, the request acquisition unit 210 accepts the notified request. The accepted request is the request regarding the subject environment.

### Effect of Seventh Embodiment

According to the seventh embodiment, it is possible to accept the request of the user by using the controller for controlling the various types of devices.

### Supplement to Seventh Embodiment

The seventh embodiment may be combined with the second embodiment to the sixth embodiment.

That is, in the second embodiment to the sixth embodiment, the entry and exit management system 110 may be replaced with the controller 140.

### Supplement to Embodiments

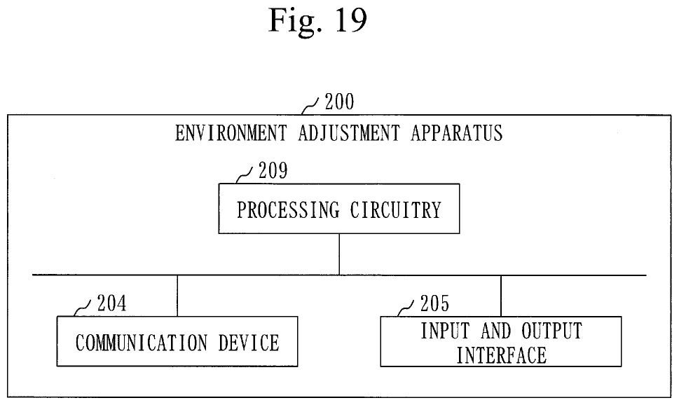

A hardware configuration of the environment adjustment apparatus 200 will be described with reference to FIG. 19.

The environment adjustment apparatus 200 includes a processing circuitry 209.

The processing circuitry 209 is hardware that realizes the request acquisition unit 210, the request arbitration unit 211, the request visualization unit 212, the control details decision unit 220, and the device control unit 230.

The processing circuitry 209 may be dedicated hardware or the processor 201 that executes a program stored in the memory 202.

When the processing circuitry 209 is the dedicated hardware, the processing circuitry 209 is, for example, a single circuit, a composite circuit, a programmed processor, a parallel-programmed processor, an ASIC, an FPGA, or a combination of these.

ASIC is an abbreviation for Application Specific Integrated Circuit.

FPGA is an abbreviation for Field Programmable Gate Array.

The environment adjustment apparatus 200 may include a plurality of processing circuits that replace the processing circuitry 209. The plurality of processing circuits share a role of the processing circuitry 209.

In the environment adjustment apparatus 200, a part of functions may be realized by the dedicated hardware, and the remaining functions may be realized by software or firmware.

In this way, the processing circuitry 209 can be realized by hardware, software, firmware, or a combination of these.

The embodiments are examples of preferred modes, and are not intended to limit the technical scope of the present invention. The embodiments may be implemented partially or may be implemented being combined with other modes. The procedures described using the flowcharts and the like may be changed as appropriate.

The environment adjustment apparatus 200 may be realized by a plurality of apparatuses. For example, the environment adjustment apparatus 200 may be replaced with an apparatus that realizes the request acquisition unit 210, the request arbitration unit 211, the request visualization unit 212, and the control details decision unit 220, and an apparatus that realizes the device control unit 230.

“Unit” which is an element of the environment adjustment apparatus 200 may be read as “process” or “step”.

### REFERENCE SIGNS LIST

100: environment adjustment system, 110: entry and exit management system, 111: authentication terminal, 120: area, 121: air conditioner and heater, 122: lighting instrument, 123: ventilation device, 130: management terminal, 140: controller, 141: authentication device, 142: request button, 200: environment adjustment apparatus, 201: processor, 202: memory, 203: auxiliary storage device, 204: communication device, 205: input and output interface, 209: processing circuitry, 210: request acquisition unit, 211: request arbitration unit, 212: request visualization unit, 220: control details decision unit, 230: device control unit. 290: storage unit.

1. An environment adjustment system comprising:
one authentication terminal; and
processing circuitry
to determine, among a plurality of types of requests associated with a plurality of manipulation patterns for authentication manipulation on the one authentication terminal, a request associated with a manipulation pattern performed on the one authentication terminal, as a request regarding a subject environment which is one type of indoor environment to be adjusted;
to decide, based on the determined request, details of adjustment by an adjustment device which is for adjusting the subject environment, and details of operation of a facility device which is a device of a different type from the adjustment device and affects the subject environment; and
to control the adjustment device according to the details of adjustment decided, and control the facility device according to the details of operation decided.

2. The environment adjustment system according to claim 1,
wherein the plurality of manipulation patterns are classified according to at least one of manipulation time spent on the authentication manipulation and the number of times of manipulation that the authentication manipulation is performed.

3. The environment adjustment system according to claim 1,
wherein the processing circuitry
acquires a plurality of requests of a plurality of users,
decides the request regarding the subject environment based on the plurality of requests acquired, and
decides the details of adjustment and the details of operation based on the decided request.

4. The environment adjustment system according to claim 1, comprising a management terminal capable of controlling each of the adjustment device and the facility device,
wherein the processing circuitry displays the request regarding the subject environment on the management terminal.

5. The environment adjustment system according to claim 1, comprising an authentication terminal in each of a plurality of areas,
wherein the processing circuitry controls an adjustment device and a facility device in an area which includes an authentication terminal which has been used.

6. The environment adjustment system according to claim 2,
wherein the processing circuitry
acquires a plurality of requests of a plurality of users,
decides the request regarding the subject environment based on the plurality of requests acquired, and
decides the details of adjustment and the details of operation based on the decided request.

7. The environment adjustment system according to claim 2, comprising a management terminal capable of controlling each of the adjustment device and the facility device,
wherein the processing circuitry displays the request regarding the subject environment on the management terminal.

8. The environment adjustment system according to claim 3, comprising a management terminal capable of controlling each of the adjustment device and the facility device,
wherein the processing circuitry displays the request regarding the subject environment on the management terminal.

9. The environment adjustment system according to claim 6, comprising a management terminal capable of controlling each of the adjustment device and the facility device,
wherein the processing circuitry displays the request regarding the subject environment on the management terminal.

10. The environment adjustment system according to claim 2, comprising an authentication terminal in each of a plurality of areas,
wherein the processing circuitry controls an adjustment device and a facility device in an area which includes an authentication terminal which has been used.

11. The environment adjustment system according to claim 3, comprising an authentication terminal in each of a plurality of areas,
wherein the processing circuitry controls an adjustment device and a facility device in an area which includes an authentication terminal which has been used.

12. The environment adjustment system according to claim 4, comprising an authentication terminal in each of a plurality of areas,
wherein the processing circuitry controls an adjustment device and a facility device in an area which includes an authentication terminal which has been used.

13. The environment adjustment system according to claim 6, comprising an authentication terminal in each of a plurality of areas,
wherein the processing circuitry controls an adjustment device and a facility device in an area which includes an authentication terminal which has been used.

14. The environment adjustment system according to claim 7, comprising an authentication terminal in each of a plurality of areas,
wherein the processing circuitry controls an adjustment device and a facility device in an area which includes an authentication terminal which has been used.

15. The environment adjustment system according to claim 8, comprising an authentication terminal in each of a plurality of areas,
wherein the processing circuitry controls an adjustment device and a facility device in an area which includes an authentication terminal which has been used.

16. The environment adjustment system according to claim 9, comprising an authentication terminal in each of a plurality of areas,
wherein the processing circuitry controls an adjustment device and a facility device in an area which includes an authentication terminal which has been used.

17. An environment adjustment method comprising:
determining, among a plurality of types of requests associated with a plurality of manipulation patterns for authentication manipulation on one authentication terminal, a request associated with a manipulation pattern performed on the one authentication terminal, as a request regarding a subject environment which is one type of indoor environment to be adjusted;
deciding, based on the determined request, details of adjustment by an adjustment device which is for adjusting the subject environment, and details of operation of a facility device which is a device of a different type from the adjustment device and affects the subject environment; and
controlling the adjustment device according to the details of adjustment decided, and controlling the facility device according to the details of operation decided.

18. A non-transitory computer readable medium storing an environment adjustment program which causes a computer to execute:
a request acquisition process of determining, among a plurality of types of requests associated with a plurality of manipulation patterns for authentication manipulation on one authentication terminal, a request associated with a manipulation pattern performed on the one authentication terminal, as a request regarding a subject environment which is one type of indoor environment to be adjusted;
a control details decision process of deciding, based on the determined request, details of adjustment by an adjustment device which is for adjusting the subject environment, and details of operation of a facility device which is a device of a different type from the adjustment device and affects the subject environment; and
a device control process of controlling the adjustment device according to the details of adjustment decided, and controlling the facility device according to the details of operation decided.
